(19) United States
(12) Patent Application Publication
(10) Pub. No.: US 2023/0411823 A1
(43) Pub. Date: Dec. 21, 2023

(54) COMPOSITE MEMBER AND STRUCTURE

(71) Applicant: NIPPON TELEGRAPH AND TELEPHONE CORPORATION, Tokyo (JP)

(72) Inventors: Yosuke TAKEUCHI, Musashino-shi, Tokyo (JP); Hisatoshi KASAHARA, Musashino-shi, Tokyo (JP); Yosuke OKAMURA, Musashino-shi, Tokyo (JP); Junichiro TAMAMATSU, Musashino-shi, Tokyo (JP)

(73) Assignee: NIPPON TELEGRAPH AND TELEPHONE CORPORATION, Tokyo (JP)

(21) Appl. No.: 18/034,384

(22) PCT Filed: Nov. 5, 2020
(86) PCT No.: PCT/JP2020/041395

§ 371 Date: Apr. 28, 2023

(51) Int. Cl. H01Q 1/22; H01Q 1/40; G01D 4/00; H01Q 1/04

(52) U.S. Cl. CPC H01Q 1/22; H01Q 1/40; G01D 4/002; H01Q 1/04

(57) ABSTRACT

A composite member (1) according to the present disclosure includes a base material (10) containing a non-metal as a main material, a metal material (20) on which a wiring pattern is formed, the metal material being embedded in the base material (10) to reinforce the base material (10), and a feeding point (21) to the metal material (20).

### TECHNICAL FIELD

The present disclosure relates to a composite member and a structure.

### BACKGROUND ART

In order to realize wireless communication between an electromagnetically shielded space and the outside, there is a method of extending an antenna outside the space. In addition, in a case where the space is a manhole or the like buried in the ground and a vehicle or a person passes over the manhole or the like, there is a method of forming a recess at the time of manufacturing a metal member such as a lid of the manhole and embedding a transmission/reception device (see, for example, Non Patent Literature 1).

### CITATION LIST

### Non Patent Literature

Non Patent Literature 1: “TUBE REAL-TIME MONITORING MANHOLE ANTENNA”, [online], [retrieved on Nov. 2, 2020], the Internet <URL:https://www.meidensha.co.jp/catalog/bb/BB524-3291.pdf>

### SUMMARY OF INVENTION

### Technical Problem

In the method of embedding the transmission/reception device in the lid in which the recess is formed, the size of the lid is limiting for the transmission/reception device, and it is particularly difficult to apply the method to a small lid. In addition, in a case where the lid includes a metal material, it is difficult to allow communication between inside and outside the shielded space. On the other hand, in a case where the lid includes a non-metallic material, it is desirable to use a high-strength and non-brittle material on the assumption that a heavy object such as a vehicle may be loaded thereon, but when fiber reinforced plastics (FRP) or the like are applied, the cost tends to be high. As described above, a member having high strength and enabling communication between the inside and the outside of the structure has been desired.

An object of the present disclosure made in view of such circumstances is to provide a member having high strength and enabling communication between the inside and the outside of a structure.

### Solution to Problem

In order to solve the above problem, a composite member according to the present disclosure includes a base material containing a non-metal as a main material, a metal material on which a wiring pattern is formed, the metal material being embedded in the base material to reinforce the base material, and a feeding point to the metal material.

In addition, a structure according to the present disclosure includes the composite member according to present disclosure, a communication unit configured to transmit information detected by a sensor, and a power supply line for connecting the feeding point and the communication unit.

### Advantageous Effects of Invention

An object of the present disclosure is to provide a member having high strength and enabling communication between the inside and the outside of a structure.

### BRIEF DESCRIPTION OF DRAWINGS

FIG. 1 is a perspective view illustrating an example of a configuration of a composite member according to an embodiment of the present disclosure.

FIG. 2A is a plan view illustrating an example of the configuration of a composite member according to an embodiment of the present disclosure.

FIG. 2B is a cross-sectional view illustrating an example of the configuration of a composite member according to an embodiment of the present disclosure.

FIG. 3 is a view illustrating directivity of an antenna in a case where a composite member according to an embodiment of the present disclosure is applied.

### DESCRIPTION OF EMBODIMENTS

Hereinafter, embodiments of the present disclosure will be described with reference to the drawings as appropriate. The embodiments described below are examples of a configuration of the present disclosure, and the present disclosure is not limited to the following embodiments.

Note that “upper” and “lower” in the following description mean directions parallel to the Z axis of the coordinate axis display drawn in the drawings, and “horizontal” means directions parallel to an XY plane of the coordinate axis display drawn in the drawings.

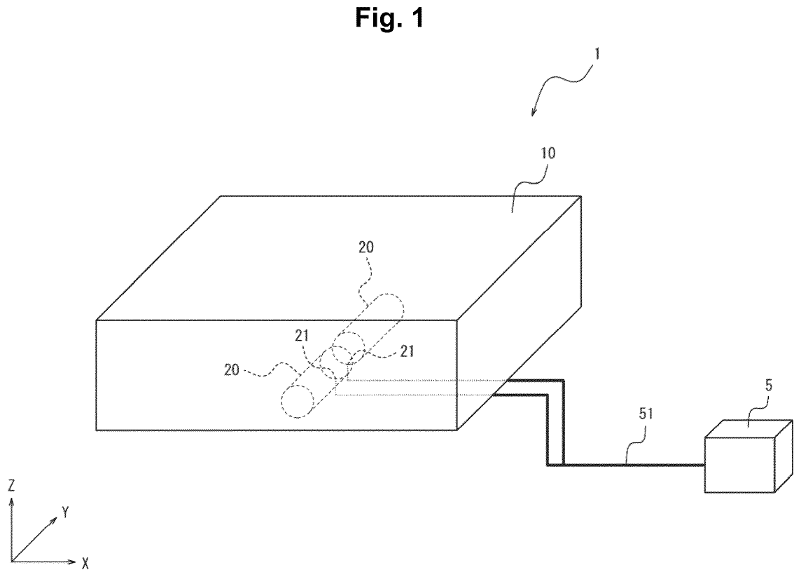

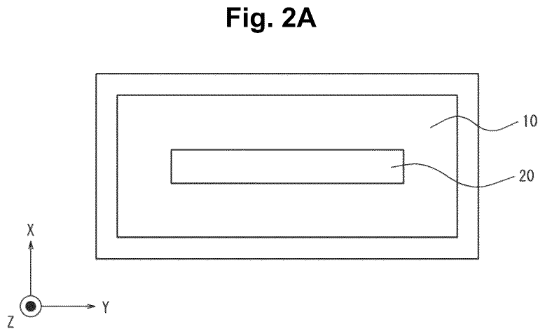

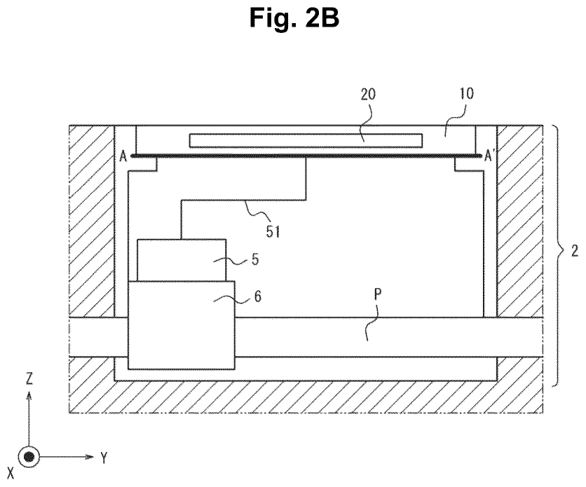

An outline of a composite member 1 according to an embodiment of the present disclosure will be described with reference to FIGS. 1, 2A, and 2B. As illustrated in FIG. 1, the composite member 1 includes a base material 10 and a metal material 20. The metal material 20 includes a feeding point 21. One end of a power supply line 51 is connected to the feeding point 21. The other end of the power supply line 51 is connected to a transmission/reception device 5. In this manner, the composite member 1 and the transmission/reception device 5 are connected via the feeding point 21 and the power supply line 51.

The composite member 1 may constitute at least a part of a door or a lid of a structure 2. In the present embodiment, the structure 2 is a meter box for a water pipe. In a case where the meter box is embedded in the ground, the composite member 1 is installed so that the upper surface is exposed on the road surface. The power supply line 51 connects the composite member 1 and the transmission/reception device 5 provided inside the meter box. The power supply line 51 may specifically include a coaxial cable and a connector.

The base material 10 has a substantially rectangular parallelepiped shape and is made of a non-metallic material having small radio wave attenuation. The base material 10 is specifically resin, concrete, mortar, glass, ceramics, or the like, and may be a combination thereof. More specifically, the resin includes polyethylene, polyvinyl chloride, polypropylene, acrylonitrile butadiene styrene (ABS), acrylic, and the like. As the base material 10, as described below, a material causing less attenuation of radio waves may be selected according to the frequency used by the antenna formed by the metal material 20. In consideration of an impact of a vehicle or the like passing on a road surface, the base material 10 is desirably made of a resin that is a non-brittle material.

In a case where concrete or mortar is used for the base material 10, the metal material 20 is placed in an alkaline environment. In this case, better anticorrosion properties are imparted to the metal material 20 than in a case where a general resin coating is applied. As described above, depending on the material of the base material 10, anticorrosion property can be imparted to the metal material 20.

The metal material 20 is embedded in the base material 10. Specifically, the metal material 20 is of steel, gold, silver, copper, aluminum, an alloy of two or more kinds thereof, or the like. In the present embodiment, the metal material 20 is made of steel. The metal material 20 has a shape of a reinforcing bar with a rib and reinforces the base material 10. The metal material 20 may have a rod shape or a plate shape, and the length, width, and height can be appropriately adjusted. In FIG. 1, the longitudinal direction of the metal material 20 extends along the Y direction, but the present invention is not limited thereto, and the longitudinal direction may extend along the X direction according to the shape of the base material 10. In FIG. 1, the cross section of the metal material 20 is circular, but is not limited thereto, and may be rectangular. The diameter of the metal material 20 can be set such that the composite member 1 has a predetermined load-bearing strength in a case where the composite member 1 constitutes a door or a lid of the structure 2. The load-bearing strength may be determined according to a place on the road surface where the door or the lid is installed, and is, for example, a load-bearing of T-2.

The metal material 20 forms an arbitrary wiring pattern and is supplied with power via the feeding point 21 to form an antenna. In FIG. 1, the metal material 20 constitutes a dipole antenna. The antenna formed of the metal material 20 is not limited thereto, and may be a monopole antenna, a loop antenna, a slot antenna, an inverted-F antenna, a Rhombic antenna, a patch antenna, an array antenna, a microstrip antenna, or the like. The dimensions of the length, diameter, and width of the metal material 20 may be freely determined according to the bandwidth used. As described above, the metal material 20 reinforces the base material 10 as a reinforcing material, and at the same time, enables transmission of a radio wave from the composite member 1 itself and reception of a radio wave to the composite member 1 itself as an antenna.

The feeding point 21 can be exposed to the outside of the composite member 1. In the example illustrated in FIGS. 2A and 2B, the feeding point 21 is exposed on the bottom surface of the base material 10, but the present invention is not limited thereto. For example, the base material 10 may be notched to expose the feeding point 21 to the outside of the base material 10. The power supply line 51 can be connected to the feeding point 21. Specifically, one end of the power supply line 51 is connected via a connector, and the other end of the power supply line 51 is connected to the transmission/reception device 5 via a connector. As a result, high-frequency power is supplied to the metal material 20 via the feeding point 21, and is sent from the metal material 20 to the transmission/reception device 5. The power supply line 51 may be connected to the feeding point 21 later, or may be connected to the feeding point 21 in advance at the time of manufacturing the composite member 1.

In FIGS. 2A and 2B, the metal material 20 embedded in the base material 10 constitutes a monopole antenna. The metal material 20 improves the strength of the door of the meter box, and at the same time, enables transmission of radio waves from the door itself and reception of radio waves to the door itself. As illustrated in FIG. 2A, the metal material 20 is disposed in a central region when viewed from the upper surface of the composite member 1.

As illustrated in FIG. 2B, in the meter box, the metal material 20 is connected to the transmission/reception device 5 via the power supply line 51. As a result, transmission and reception of information between the outside and the inside of the meter box can be performed via the transmission/reception device 5 and the composite member 1. The information includes, for example, information on the quality, pressure, and flow rate of water in a water pipe P measured by the sensor 6 provided in the water pipe P.

Note that the sensor 6 inside the meter box may be a smart meter. Details of meter reading by the smart meter are disclosed in, for example, Document 1 described below, and thus are omitted here.

Document 1: “Tokyo Metropolitan Government Bureau of Waterworks, Press Release”, [online], [retrieved on Nov. 2, 2020], the Internet <URL: https://www.waterworks.metro.tokyo.jp/press/h31/press200121-01.html>

The transmission/reception device 5 is connected to the sensor 6 in a wired or wireless manner. The transmission/reception device 5 includes a control unit and a communication unit. The control unit of the transmission/reception device 5 acquires information on water measured by the sensor 6 from the sensor 6 via the communication unit. The control unit transmits the acquired information via the communication unit and the power supply line 51. The information thus transmitted from the transmission/reception device 5 is transmitted to the outside of the meter box via the composite member 1. Further, the transmission/reception device 5 may receive a signal requesting acquisition of information from the outside of the meter box, and acquire and transmit the information according to the received signal.

The control unit of the transmission/reception device 5 includes one or more processors. In the present embodiment, the “processor” is a general-purpose processor or a dedicated processor specialized for a specific process, but is not limited thereto. It may be configured by dedicated hardware, or may be configured by a general-purpose processor or a processor specialized for specific processing. The control unit executes processing related to the operation of the entire transmission/reception device 5 while controlling each unit of the transmission/reception device 5.

The communication unit of the transmission/reception device 5 includes at least one communication interface. The communication interface is, for example, an interface compatible with near field communication such as Bluetooth (registered trademark) or a LAN interface. The communication unit receives information used for the operation of the transmission/reception device 5, and also transmits the information obtained by the operation of the transmission/reception device 5.

In the present embodiment, the composite member 1 constitutes a door of a meter box for a water pipe as the structure 2, but the present invention is not limited thereto. For example, the composite member 1 may constitute a lid of various storage tanks such as side grooves, manholes, and silos as the structure 2. The composite member 1 may constitute, for example, a door of a warehouse room, an electric room, a machine room, a storage, a cargo room of a cargo vehicle or a cargo train, or the like as the structure 2. In this case, the transmission/reception device 5 can acquire information measured by the sensor 6 provided inside the structure 2 and transmit the information to the outside of the structure 2 via the composite member 1. The sensor 6 includes various sensors such as a temperature and humidity sensor, a water level sensor, an odor sensor, a corrosion sensor, and a gas sensor.

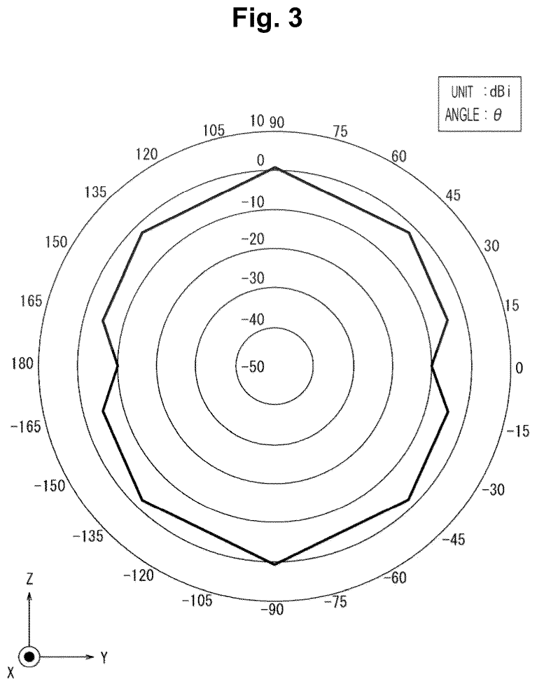

FIG. 3 illustrates directivity in a case where the metal material 20 constituting the dipole antenna is applied to the door of the meter box as the structure 2. From FIG. 3, it can be seen that radio waves are also emitted below the metal material 20, that is, in the direction inside the meter box. The radio wave radiated in the direction toward the inside of the meter box may be reflected to the upper side of the metal material 20 using a reflector to enhance directivity to the outside of the meter box. The reflector is made of metal, for example. The reflector can be provided on the bottom surface of composite member 1 as indicated by line A-A′ in FIG. 2B.

As described above, the composite member 1 according to the present embodiment includes a base material 10 containing a non-metal as a main material, a metal material 20 on which a wiring pattern is formed, the metal material 20 being embedded in the base material 10 to reinforce the base material 10, and a feeding point 21 to the metal material 20.

According to the present embodiment, the metal material 20 in the composite member 1 can simultaneously realize the reinforcing effect and the antenna function. Since the metal material 20 functions as a reinforcing bar in the base material 10, strength corresponding to a metal product can be realized at low cost. In addition, cost can be suppressed by using a resin or the like which is a general material for the base material 10. Therefore, the composite member 1 can provide a member having high strength and enabling communication between the inside and the outside of the structure 2.

As described above, in the composite member 1 according to the present embodiment, the metal material 20 constitutes an antenna due to the shape of the wiring pattern.

According to the present embodiment, the wiring pattern of the metal material 20 can be examined, and the directivity of the antenna formed by the metal material 20 can be freely designed. The metal material 20 and the transmission/reception device 5 are connected, and radio wave transmission without attenuation can be realized directly from the composite member 1. Further, the transmission/reception device 5 and the antenna are separated from each other, so that the lid or the door of the structure 2 can be downsized. Therefore, the composite member 1 can provide a member having high strength and enabling communication between the inside and the outside of the structure 2.

As described above, in the composite member 1 according to the present embodiment, the base material 10 includes resin, concrete, mortar, glass, ceramics, or a combination thereof.

According to the present embodiment, it is possible to provide the composite member 1 using a non-brittle material and an inexpensive material such as a resin as the base material 10. Therefore, the composite member 1 can provide a member having high strength and enabling communication between the inside and the outside of the structure 2.

As described above, in a case where the base material 10 is concrete or mortar, the metal material 20 is imparted with anticorrosion property by the base material 10, and an anticorrosion film can be imparted to the metal material 20 in the base material 10. As compared with the case where the metal material 20 is coated with a resin, the metal material 20 can ensure better anticorrosion properties to form an antenna. Therefore, the composite member 1 can provide a member having high strength and enabling communication between the inside and the outside of the structure 2.

As described above, in the composite member 1 according to the present embodiment, the feeding point 21 is exposed to the outside of the base material 10. Therefore, the power supply line 51 can be easily connected to the feeding point 21. As a result, even in a case where the power supply line 51 is deteriorated, replacement work can be quickly performed, and communication via the composite member 1 can be stably maintained. Therefore, the composite member 1 can provide a member having high strength and enabling communication between the inside and the outside of the structure 2.

As described above, the structure 2 according to the present embodiment includes the composite member 1 according to present embodiment, a communication unit configured to transmit information detected by a sensor 6, and a power supply line 51 for connecting the feeding point 21 and the communication unit.

According to the present embodiment, the transmission/reception device 5 can transmit the information detected by the sensor 6 inside the structure 2 to the outside of the structure 2 via the composite member 1 and the power supply line 51. By connecting the composite member 1 having an antenna function and the transmission/reception device 5 having a communication unit by the power supply line 51, more reliable communication between the inside and the outside of the structure 2 becomes possible.

As described above, in the structure 2 according to the present embodiment, the composite member 1 constitutes at least a part of the door or the lid of the structure 2.

According to the present embodiment, the composite member 1 is disposed at the boundary between the inside and the outside of the structure 2. By the composite member 1 itself realizing the antenna function, stable communication between the inside and the outside of the structure 2 can be realized.

As described above, the structure 2 according to the present embodiment is a meter box. In this case, information detected by the sensor 6 inside the meter box can be transmitted to the outside via the transmission/reception device 5 and the composite member 1. Since information can be appropriately acquired from the outside of the meter box, manual confirmation is unnecessary, and efficiency can be improved.

Although the present disclosure has been described based on the drawings and embodiments, it should be noted that those skilled in the art can easily make various modifications and amendments based on the present disclosure. Therefore, it should be noted that these modifications and amendments are included in the scope of the present disclosure.

As a modification example of the present disclosure, the base material 10 of the composite member 1 may be a combination of different materials. For example, a part of the base material 10 may be made of resin such as acrylic, and the other part may be made of concrete.

According to this modification, the portion of the base material 10 made of a resin such as acrylic makes it easier for radio waves to pass through, and the part made of concrete enhances the anticorrosion property of the metal material 20. As described above, by increasing the degree of freedom of design of the base material 10, the strength of the composite member 1 can be increased, and efficient communication can be realized.

### REFERENCE SIGNS LIST

1 Composite member
2 Structure
5 Transmission/reception device
6 Sensor
10 Base material
20 Metal material
21 Feeding point
51 Power supply line

1. A composite member comprising:
a base material containing a non-metal as a main material;
a metal material on which a wiring pattern is formed, the metal material being embedded in the base material to reinforce the base material; and
a feeding point to the metal material.

2. The composite member according to claim 1, wherein the metal material constitutes an antenna due to a shape of the wiring pattern.

3. The composite member according to claim 1, wherein the base material includes resin, concrete, mortar, glass, ceramics, or a combination thereof.

4. The composite member according to claim 3, wherein the base material is concrete or mortar, and
the metal material is provided with anticorrosion property by the base material.

5. The composite member according to claim 1, wherein the feeding point is exposed to the outside of the base material.

6. A structure comprising:
the composite member according to claim 1;
communication circuitry configured to transmit information detected by a sensor; and
a power supply line for connecting the feeding point and the communication circuitry.

7. The structure according to claim 6, wherein the composite member constitutes at least a part of a door or a lid of the structure.

8. The structure according to claim 6, wherein the structure is a meter box.
